(19) United States
(12) Patent Application Publication
(10) Pub. No.: US 2021/0322132 A1
(43) Pub. Date: Oct. 21, 2021

(54) ELECTRICAL TOOTHBRUSH TRANSMISSION CONNECTION STRUCTURE

(71) Applicant: JIASHAN D-MAX ELECTRONICS CO., LTD., Jiaxing City (CN)

(72) Inventors: Wei-Chuan Wang, Jiaxing City (CN); Qiang Wei, Jiaxing City (CN)

(21) Appl. No.: 16/849,980

(22) Filed: Apr. 15, 2020

(51) Int. Cl. A61C 1/18; H01R 4/58; H02K 7/00; A61C 17/34

(52) U.S. Cl. CPC A61C 1/185; H01R 4/58; A61C 17/3481; A61C 17/34; H02K 7/003

(57) ABSTRACT

An electrical toothbrush transmission connection structure includes a transmission shaft and a motor. The transmission shaft has a first sleeve at one end. The first sleeve has a first connection section. The motor has a rotary shaft. A second sleeve is disposed on the rotary shaft. The second sleeve has a second connection section. The first and second connection sections have corresponding cross-sectional shape and are correspondingly connected with each other so that the electrical toothbrush transmission connection structure has better transmission connection structure and effect.

### BACKGROUND OF THE INVENTION

### 1. Field of the Invention

The present invention relates generally to a transmission connection structure, and more particularly to an electrical toothbrush transmission connection structure.

### 2. Description of the Related Art

The electrical toothbrush is a convenient tooth cleaning tool. The electrical toothbrush is vibrated to produce bubbles from the toothpaste so as to deeply clean up a user's teeth. The conventional electrical toothbrush has a transmission shaft connected with the rotary shaft of a motor so as to transmit the rotational motion of the motor as a vibration source of the electrical toothbrush.

However, the transmission structure and the rotary shaft of the motor of the conventional electrical toothbrush are not connected by a good means.

It is therefore tried by the applicant to provide an electrical toothbrush transmission connection structure to solve the problem existing in the conventional electrical toothbrush.

### SUMMARY OF THE INVENTION

It is therefore a primary object of the present invention to provide an electrical toothbrush transmission connection structure, which provides better transmission connection structure and effect.

To achieve the above and other objects, the electrical toothbrush transmission connection structure of the present invention includes a transmission shaft and a motor. The transmission shaft has a first sleeve at one end. The first sleeve has a first connection section. The motor has a rotary shaft. A second sleeve is disposed on the rotary shaft. The second sleeve has a second connection section. The first and second connection sections have corresponding cross-sectional shape and are correspondingly connected with each other.

By means of the design of the present invention, the electrical toothbrush transmission connection structure has better transmission connection structure and effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a preferred embodiment of the electrical toothbrush transmission connection structure of the present invention;

FIG. 2 is a perspective assembled view of the preferred embodiment of the electrical toothbrush transmission connection structure of the present invention;

FIGS. 3a and 3b are perspective views showing the cross-sectional shape of the first and second connection sections of the electrical toothbrush transmission connection structure of the present invention;

FIGS. 4a and 4b are perspective views showing the cross-sectional shape of the first and second connection sections of the electrical toothbrush transmission connection structure of the present invention;

FIGS. 5a and 5b are perspective views showing the cross-sectional shape of the first and second connection sections of the electrical toothbrush transmission connection structure of the present invention;

FIGS. 6a and 6b are perspective views showing the cross-sectional shape of the first and second connection sections of the electrical toothbrush transmission connection structure of the present invention;

FIGS. 7a and 7b are perspective views showing the cross-sectional shape of the first and second connection sections of the electrical toothbrush transmission connection structure of the present invention;

FIGS. 8a and 8b are perspective views showing the cross-sectional shape of the first and second connection sections of the electrical toothbrush transmission connection structure of the present invention; and

FIG. 9 is a perspective exploded view of a modified embodiment of the electrical toothbrush transmission connection structure of the present invention.

### DETAILED DESCRIPTION OF THE PREFERRED EMBODIMENTS

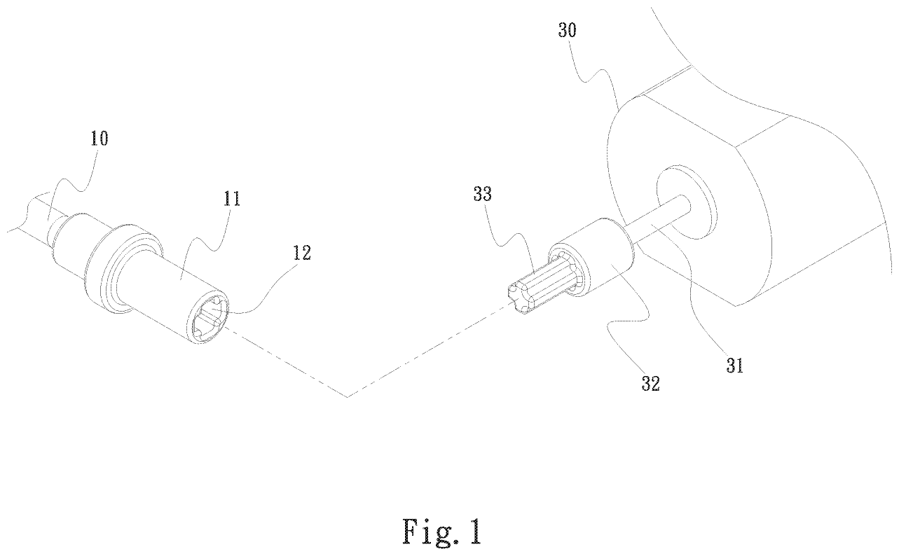

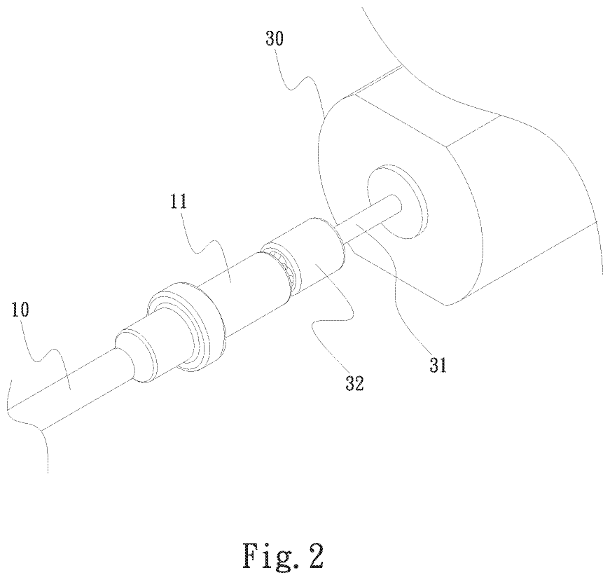

Please refer to FIGS. 1 and 2. FIG. 1 is a perspective exploded view of a preferred embodiment of the electrical toothbrush transmission connection structure of the present invention. FIG. 2 is a perspective assembled view of the preferred embodiment of the electrical toothbrush transmission connection structure of the present invention. As shown in the drawings, the electrical toothbrush transmission connection structure of the present invention includes a transmission shaft 10 and a motor 30.

The transmission shaft 10 has a first sleeve 11 at one end. The first sleeve 11 has a first connection section 12. The first connection section 12 is recessed on the first sleeve 11.

The motor 30 has a rotary shaft 31. A second sleeve 32 is disposed on the rotary shaft 31. The second sleeve 32 has a second connection section 33. The second connection section 33 protrudes from the second sleeve 32. The first and second connection sections 12, 33 have corresponding cross-sectional shape and are correspondingly connected with each other.

When the motor 3 rotates, the rotational motion of the motor 3 is transmitted to the transmission shaft 10.

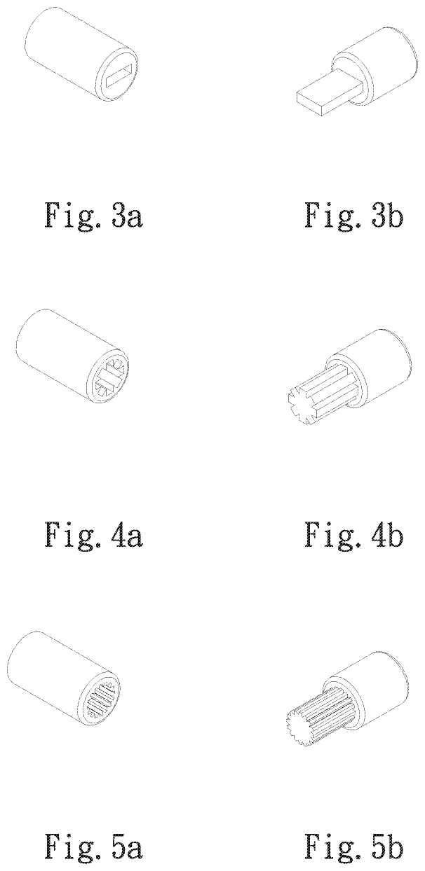

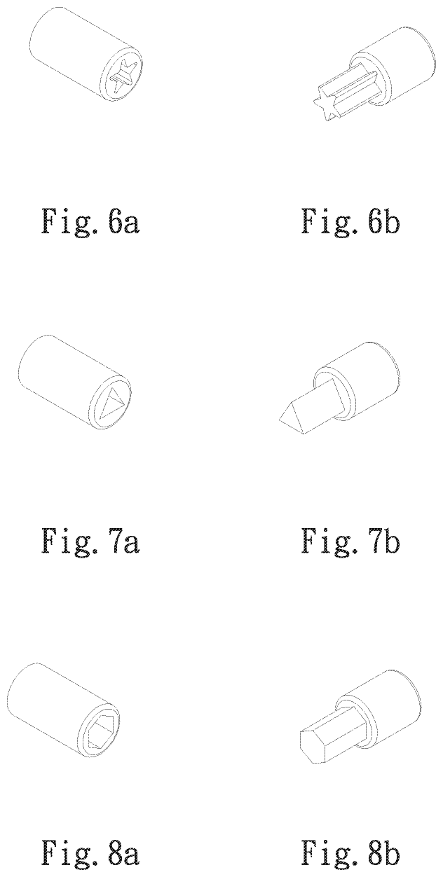

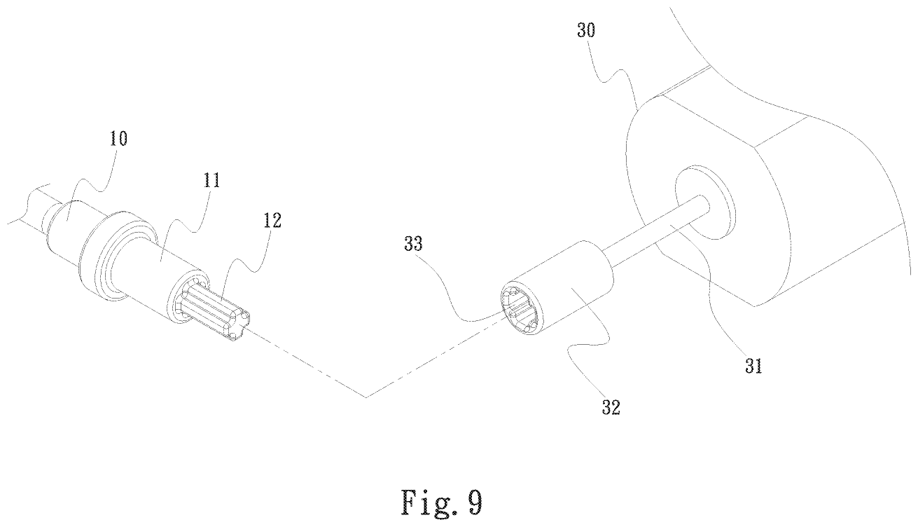

The first connection section 12 has a cross-shaped cross section and the second connection section 33 also has a cross-shaped cross section corresponding to the first connection section 12. Alternatively, the first connection section 12 can have a slot-shaped cross section (as shown in FIG. 3a), a [symbol] -shaped cross section (as shown in FIG. 4a), a gear-shaped cross section (as shown in FIG. 5a), a star-shaped cross section (as shown in FIG. 6a), a polygonal cross section (as shown in FIGS. 7a and 8a) or any other geometrical cross section. Corresponding to the first connection section 12, the second connection section 33 alternatively can have a slot-shaped cross section (as shown in FIG. 3b), a [symbol] -shaped cross section (as shown in FIG. 4b), a gear-shaped cross section (as shown in FIG. 5b), a star-shaped cross section (as shown in FIG. 6b), a polygonal cross section (as shown in FIGS. 7b and 8b) or any other geometrical cross section.

The first connection section 12 and the second connection section 33 are selectively securely connected with each other by means of adhesion, engagement, press fit or welding.

In a modified embodiment, the first connection section 12 protrudes from the first sleeve 11, while the second connection section 33 is recessed on the second sleeve 32.

By means of the design of the electrical toothbrush transmission connection structure of the present invention, the first and second connection sections 12, 33 have corresponding cross-sectional shape and are correspondingly connected with each other so that the rotational motion of the motor can be transmitted to the transmission shaft. The electrical toothbrush transmission connection structure of the present invention has better transmission connection structure and effect.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. An electrical toothbrush transmission connection structure comprising:
a transmission shaft having a first sleeve at one end, the first sleeve having a first connection section; and
a motor having a rotary shaft, a second sleeve being disposed on the rotary shaft, the second sleeve having a second connection section, the first and second connection sections having corresponding cross-sectional shape and being correspondingly connected with each other.

2. The electrical toothbrush transmission connection structure as claimed in claim 1, wherein the first connection section is recessed on the first sleeve, while the second connection section protrudes from the second sleeve.

3. The electrical toothbrush transmission connection structure as claimed in claim 1, wherein the first connection section protrudes from the first sleeve, while the second connection section is recessed on the second sleeve.

4. The electrical toothbrush transmission connection structure as claimed in claim 1, wherein the first connection section has a slot-shaped cross section, a cross-shaped cross section, a star-shaped cross section, a [symbol] -shaped cross section or a gear-shaped cross section.

5. The electrical toothbrush transmission connection structure as claimed in claim 1, wherein the second connection section has a slot-shaped cross section, a cross-shaped cross section, a star-shaped cross section, a [symbol] -shaped cross section or a gear-shaped cross section.

6. The electrical toothbrush transmission connection structure as claimed in claim 1, wherein the first connection section has a polygonal cross section or any other geometrical cross section.

7. The electrical toothbrush transmission connection structure as claimed in claim 1, wherein the second connection section has a polygonal cross section or any other geometrical cross section.

8. The electrical toothbrush transmission connection structure as claimed in claim 1, wherein the first connection section and the second connection section are selectively securely connected with each other by means of adhesion, engagement, press fit or welding.
